(19) United States
(12) Patent Application Publication
(10) Pub. No.: US 2015/0083053 A1
(43) Pub. Date: Mar. 26, 2015

(54) CONTACT UNIT FOR AN ANIMAL TRAINING SYSTEM

(71) Applicant: DOGWATCH INC., Natick, MA (US)

(72) Inventors: James T. MacDonald, Pepperell, MA (US); Christopher Aiston, Mont Vernon, NH (US)

(73) Assignee: DOGWATCH INC., Natick, MA (US)

(21) Appl. No.: 14/035,368

(22) Filed: Sep. 24, 2013

(51) Int. Cl. A01K 15/02; B29C 70/72; A01K 27/00

(52) U.S. Cl. CPC A01K 15/021; A01K 27/009; A01K 27/001; B29C 70/72; B29K 2995/0005; B29L 2031/34
USPC 119/720; 264/104

(57) ABSTRACT

A contact unit for an animal training system and a method for producing the same. The contact unit includes at least one base portion formed from a moldable electrically non-conductive material and at least two contact probes formed from a moldable electrically conductive material. At least one contact probe is provided in each base portion. The contact probes include integral probe tips that extend outward from the at least one base portion. The contact unit is releasably mountable to a controller housing. A collar is used to mount the controller housing and the contact unit around the neck of the animal to maintain the probe tips in contact with the skin of the animal.

### STATEMENT REGARDING FEDERALLY SPONSORED RESEARCH OR DEVELOPMENT

Not Applicable

### BACKGROUND OF THE INVENTION

Various animal training systems are known in the art. Typically, in such systems, a contact unit has a pair of conductive probes that extend from an RF receiver housing and are retained against the skin of an animal via a collar that is secured around the neck of the animal. A stimulus in the form of an electric shock may be provided to the animal via the conductive probes of the contact unit in response to undesired behaviors to train the animal not to engage in such behaviors.

In one form of animal training system, an antenna wire is buried in the ground or otherwise disposed so as to define an area in which an animal, such as a pet or livestock, is/are to be constrained or to define an area from which an animal is to be excluded. The antenna wire is energized to provide an RF field in the vicinity of the wire. When the animal approaches the antenna wire and the strength of the RF signal received by the RF receiver exceeds a specified threshold, the RF receiver may generate a stimulus in the form of an electric shock that is conveyed to the animal via the conductive probes. By providing the animal with an electrical stimulus when it approaches the antenna wire, the animal is trained not to approach the antenna wire and thus remains within or outside of the defined area.

In another form of animal training system, a trainer controls a transmitter that is capable of producing an RF signal. The RF signal is received by an RF receiver secured around the neck of the animal via a collar. In response to the receipt of the RF signal, the RF receiver conveys an electrical stimulus to the animal via the conductive probes. By applying an electrical stimulus to the animal when the trainer observes undesirable behaviors by the animal, the animal can be trained not to engage in such behaviors.

RF receivers that include replaceable metallic probes and that are mountable to a collar worn by a pet are known. RF receivers are also known that include conductive plastic probes which are molded into the base of an RF receiver housing. The replacement of the conductive plastic probes in this embodiment disadvantageously requires disassembly of the RF receiver housing and replacement of the entire base portion of the housing which includes the conductive probes, or alternatively, replacement of the entire housing for the RF receiver.

It would therefore be desirable to have a contact unit that was distinct from the RF receiver housing to permit replacement of the contact unit should such be required without replacement of all or a part of the RF receiver housing. Additionally, it would be desirable to provide a contact unit that was manufacturable in high volume and at low cost and that could be produced in various sizes to accommodate animals of different size and hair configurations.

### BRIEF SUMMARY OF THE INVENTION

A contact unit includes two or more electrically conductive contact probes and one or more non-conductive base portions. The electrically conductive contact probes are molded into the one or more electrically non-conductive base portions. The contact unit is mountable to a housing of an RF receiver via at least one fastener to releasably secure the contact unit to the housing and to electrically interconnect the conductive contact probes to conductive contacts mounted to the RF receiver housing. The conductive contacts are electrically coupled to stimulus generating circuitry within the RF receiver.

The contact probes are integrally formed single piece molded components. Each contact probe includes a probe tip portion for making conductive contact with the skin of an animal and an interconnection portion for conductively coupling the respective contact probe to a corresponding conductive contact on the RF receiver housing.

In one embodiment, the interconnection portion includes an opening sized to receive a fastener that is used to secure the interconnection portion of the contact probe to the conductive contact mounted to the RF receiver housing. Additionally, the fastener may be conductive and serve to electrically interconnect the interconnection to a corresponding conductive contact by engagement of the conductive fastener with the interconnection portion and the conductive contact.

The interconnection portion may be conductively coupled to the probe tip portion via a stem portion that extends between the interconnection portion and the probe tip portion.

In another embodiment, the contact unit is releasably secured to the RF receiver housing via a non-conductive fastener. The interconnection portion of the contact probe is disposed in conductive abutting relation with a corresponding conductive contact that is mounted to the RF receiver housing when the contact unit is mounted to the housing. The non-conductive fastener serves to maintain the interconnection portion in conductive abutting relation with a corresponding conductive contact mounted in the RF receiver housing.

The contact unit may be fabricated by molding the contact probes in a first molding operation and then molding one or more contact probes into one or more base portions. The contact probes are molded into the base portion(s) in a second molding operation using insert or over-molding techniques.

Alternatively, the contact unit may be fabricated by first molding one or more non-conductive base portions and then molding one or more of the contact probes in each base portion in a second molding operation.

The contact unit may be molded in various sizes and probe tip configurations to accommodate animals of different sizes and hair characteristics.

In addition to the use of the contact unit in conjunction with an RF Receiver as described above, the contact unit may be employed with a controller that produces an electrical stimulus in response to an audible, pressure, vibration, linear or rotary motion input or any other suitable input.

Other features, advantages and aspects of the presently disclosed contact unit will be apparent to those skilled in the art in view of the drawings and detailed description that follows.

### BRIEF DESCRIPTION OF THE SEVERAL VIEWS OF THE DRAWINGS

The invention will be more fully understood by reference to the following Detailed Description of the Invention in conjunction with the drawings of which:

FIG. 1A is a perspective view of a contact unit having a molded non-conductive base portion and molded spaced contact probes in accordance with the present invention;

FIG. 1B is an exploded perspective view illustrating the molded contact probes and the base portion that form the contact unit of FIG. 1A;

FIG. 2 is a perspective view of a conductive contact probe employed in the contact unit of FIG. 1;

FIG. 3 is a perspective view of the molded non-conductive base portion in the contact unit of FIG. 1;

FIG. 4 is a cross-sectional cutaway view through a longitudinal centerline through the contact unit of FIG. 1A;

FIG. 5 is an exploded assembly drawing illustrating the mounting of the contact unit of FIG. 1A to a collar and RF receiver in accordance with one embodiment of the invention;

FIG. 6 is another embodiment of a contact unit in accordance with the present invention that includes two base portions with one contact probe in each base portion;

FIG. 7 is an exploded assembly drawing of another embodiment of a contact unit in accordance with the present invention that employs a single fastener for securing the contact unit to a RF receiver housing;

FIG. 8 is another embodiment of a contact unit in accordance with the present invention that includes a single base portion and four contact probes molded therein; and

FIG. 9 is another embodiment of a contact unit in accordance with the present invention that includes two opposing base portions and two contact probes in each base portion.

### DETAILED DESCRIPTION OF THE INVENTION

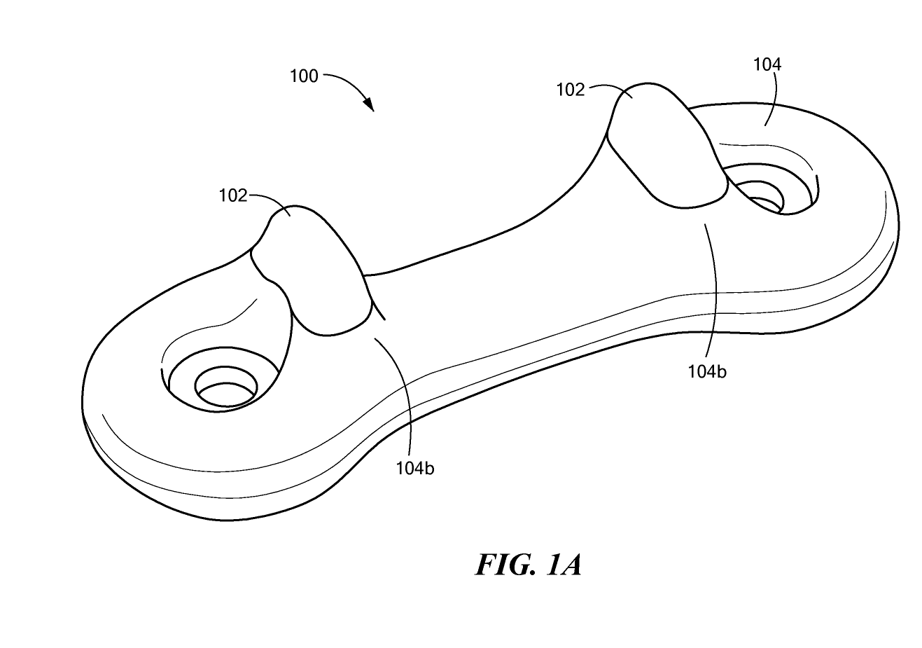

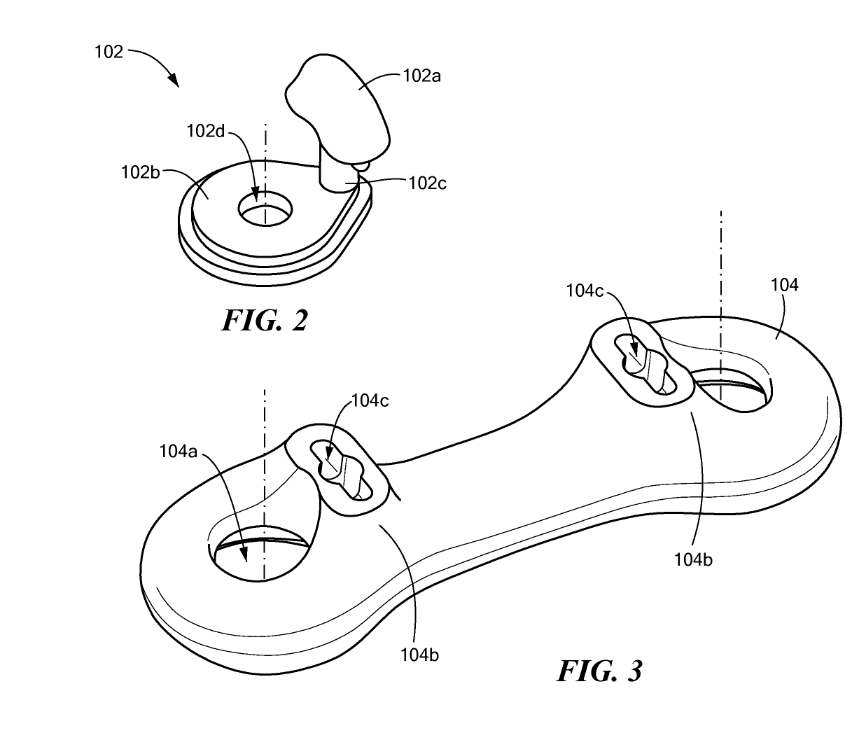

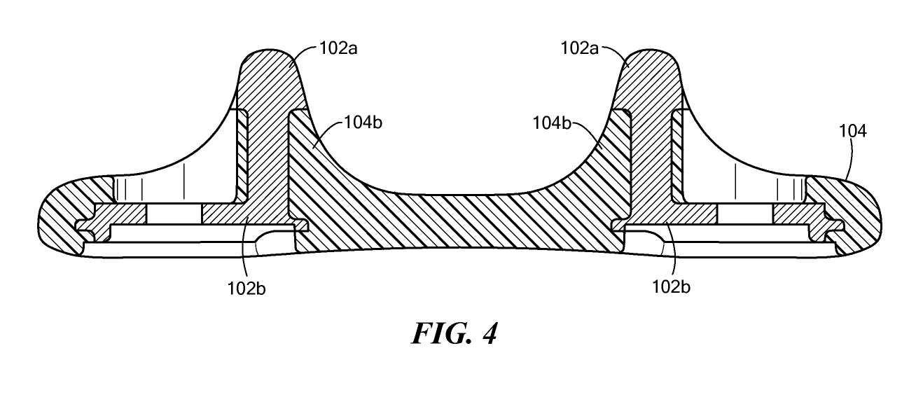

In accordance with the present invention, a molded contact unit for use in an animal training system is disclosed. Referring to FIGS. 1A-5, the contact unit 100 includes a pair of spaced electrically conductive molded contact probes 102 disposed in a nonconductive molded base portion 104. The contact probes 102 in the illustrated embodiment include a probe tip portion 102a and an interconnection portion 102b. The contact probes also include a stem portion 102c extending from and conductively coupling the interconnection portion 102b to the probe tip portion 102a. The probe tip portion 102a has a generally dome shaped upper surface for making contact with the skin of animal. The interconnection portion has a bottom surface that is configured to abut and conductively mate with corresponding conductive contacts 108 mounted in the RF receiver housing 110. In the embodiment illustrated in FIGS. 1A-5, the interconnection portion 102b includes an opening 102d sized to accommodate a fastener that is used to secure the contact unit 102 to an RF receiver 110 (FIG. 4) as subsequently discussed. In the exemplary illustrated embodiment, the interconnection portion 102b is a generally washer shaped portion that includes a side section extending from one side thereof which is generally V-shaped. The stem portion 102c of the contact probe 102, in the illustrated embodiment, extends upward from the interconnection portion 102b to the probe tip portion 102a. As illustrated in FIG. 1B, wings 102e extend outward from the stem portion 102c and confront surfaces of the passages 104c in the base portion 104.

The contact probes 102 are formed of an electrically conductive moldable polymer such as a conductive plastic, a conductive rubber or any other suitable moldable conductive material. It is recognized that the electrical conductively may be achieved via the addition of additives to an otherwise non-conductive polymeric material and the reference to a conductive polymer herein includes polymers that are conductive by reason of the addition of additives, such as carbon black, fine metal particles or other additives that impart conductive characteristics to otherwise non-conductive materials. By way of example, and not limitation, the contact probes 102 may be fabricated from Nylon 66 which is available from DuPont™ with a conductive additive such as carbon black or fine metal particles.

In the illustrated embodiment, the base portion 104 is formed of an electrically nonconductive moldable polymer such as an electrically nonconductive plastic, an electrically nonconductive rubber or any other suitable moldable non-conductive material. By way of example, and not limitation, the base portion 104 may be fabricated from Nylon 66 available from DuPont™. The base portion 104, as illustrated, is an elongated member having a pair of through-holes 104a located at opposing ends and a pair of upwardly extending spaced pedestals 104b disposed inwardly of the through-holes 104a. The upper surface of each pedestal 104 is in the form of a plateau which, in the exemplary embodiment is generally planar. The probe tip portions 102a extend upward from the two upstanding pedestals 104b formed in the base portion 104. The center portion of the passages 104c extend through the pedestals 104b. Surfaces of the upper portion of the passages 104c define slots in the base portion 104 which also define the outer surface of the wings 102e. The wings 102e extending from the stem portions 102c provide added support and stability for the contact probes 102 molded within the base portion 104.

The contact unit 100 is formed in first and second molding operations in which the contact probes 102 are first formed in one or more first molds in a first molding operation. The contact probes 102 are then inserted into a second mold and spaced and aligned such that the open areas of the second mold correspond to the structure of the base portion 104 to be formed. A nonconductive moldable polymeric material is then injected into the second mold to form the base portion 104 around the contact probes 102 and thereby produce the contact unit 100.

Alternatively, the contact unit 100 may be formed in first and second molding operations in which the base portion 104 is first molded and the contact probes are formed in a secondary molding operation. In the first molding operation, the base portion 104 is formed of a moldable nonconductive polymeric material in a first mold. The base portion 104 is then inserted and aligned in a second mold that is configured such that the open areas within the mold correspond to the structure of the contact probes 102. An electrically conductive polymeric material is then injected into the second mold to form the contact probes 102 and produce the finished contact unit 100 as depicted in FIG. 1A.

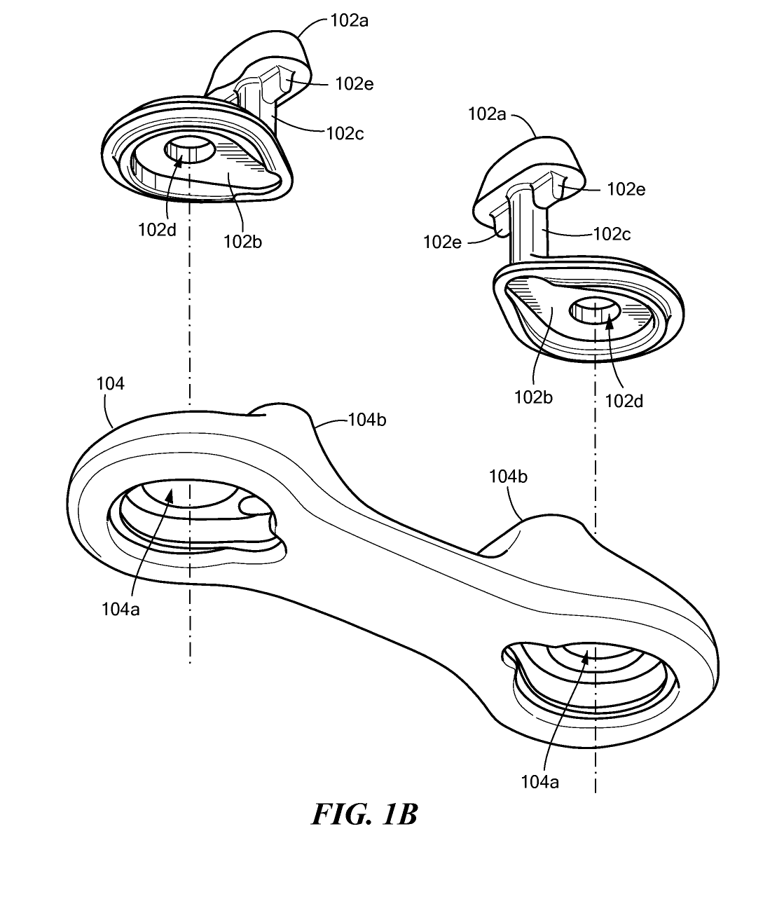

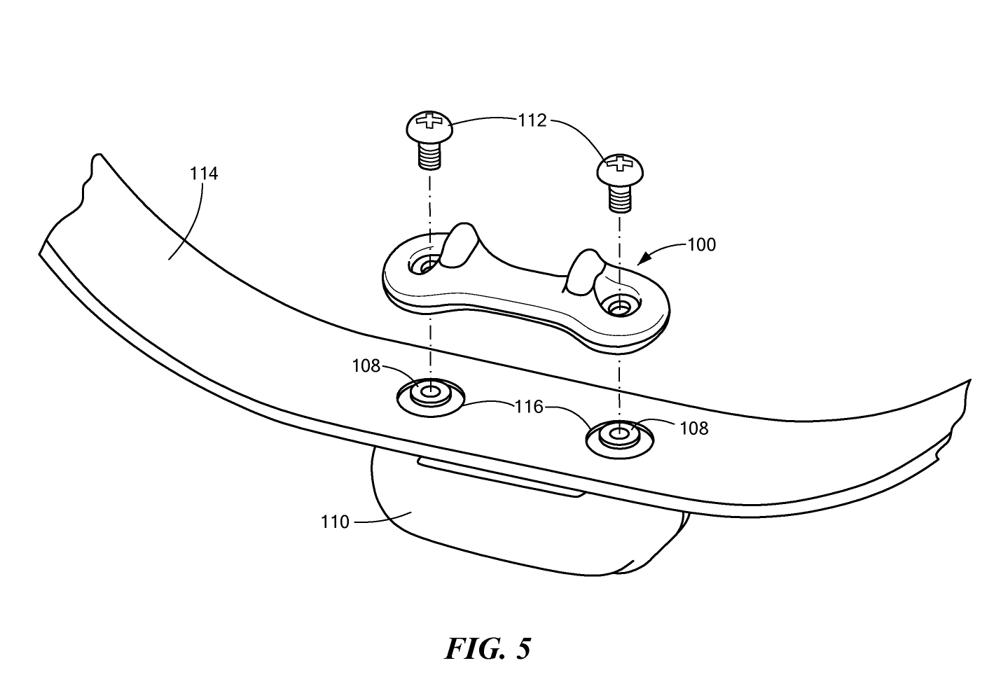

In the illustrated embodiment, the contact unit 100 is releasably mountable to conductive contacts 108 of an RF receiver 110 via fasteners 112, such as screws, as illustrated in FIG. 5. The fasteners 112, may be conductive or nonconductive fasteners and extend through the openings 102d (see FIG. 2) in the interconnection portion 102b. When conductive fasteners 112 are employed, they provide an electrical connection between the contact probes 102 and the electrical contacts 108 of the RF receiver 110 by abutting engagement with the interconnection portion and engagement with the conductive contacts 108 mounted in the RF receiver housing. The conductive contacts 108 in turn are coupled to the electrical stimulus generating circuitry (not shown) within the RF receiver 110. RF receivers and stimulus generating circuitry of the type herein employed are generally known in the art and therefore not discussed in further detail herein.

The fasteners 112 in the illustrative embodiment thus releasably secure the contact unit 100 to the RF receiver 110 and electrically interconnect the contact probes 102 of the contact unit 100 to the conductive contacts 108 mounted in the housing of the RF receiver 110. The contact probes 102 may thereby be energized by the electrical stimulus generating circuitry within the RF receiver 110.

The fasteners 112 may also be nonconductive fasteners which secure the contact unit 100 to the RF receiver housing. When nonconductive fasteners 112 are employed, the undersurface of the interconnection portion 102b is configured to mate with the conductive contacts 108 in abutting relation. The nonconductive fasteners 112 serve to secure the undersurface of the interconnection portions 102b in conductive abutting relation with the upper surface of corresponding conductive contacts 108.

A collar 114, that is configured to be secured around the neck of an animal, has through-holes 116 spaced so as to align with the openings 102d of the contact probes 102. The collar 114 may be disposed between the contact unit 100 and the RF receiver 110 as illustrated in FIG. 4. In this embodiment, the conductive fasteners 112 extend through the openings 102d of the contact probes 102 and through the through-holes 116 of the collar 114 and engage the electrical contacts 108 of the RF receiver 110 to releasably secure the contact unit 100 and the RF receiver 110 to the collar 114.

Alternatively, it should be recognized that a collar may be mounted to the RF receiver 110 housing or extend through strap retaining members formed in the housing rather than being disposed between the contact unit 100 and the RF receiver 110 as depicted in FIG. 5.

While FIGS. 1A-5 depict a contact unit in which two contact probes are molded into a single base portion, one or more contact probes may be formed within a single base portion and two or more base portions may be employed to form the contact unit. In this circumstance, each base portion of the contact unit is releasably mounted to the RF receiver housing with the interconnection portion of each contact probe electrically interconnected to a corresponding electrical contact mounted to the RF receiver housing.

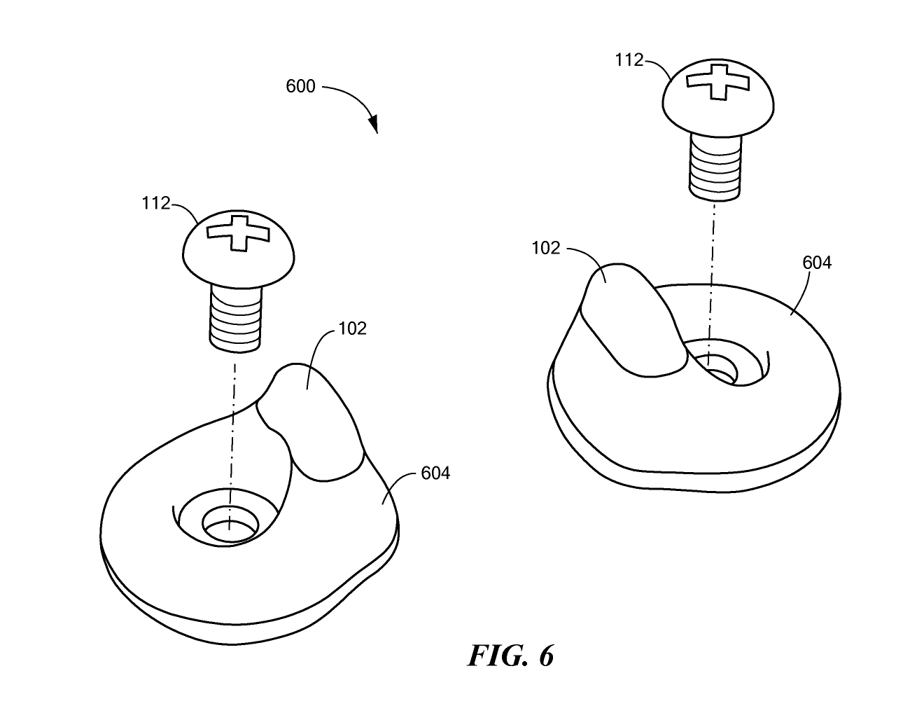

FIG. 6 illustrates an embodiment of a contact unit 600 in which a contact probe 102 is provided in each of two separate molded base portions 604. This embodiment provides some flexibility in that the spacing between the base portions 604 may be varied when mounting the base portions to a receiver housing to accommodate animals having different neck sizes and hair configurations. It is recognized that the mounting of base portions 604 to the receiver housing requires adjustment in the spacing of the conductive contacts of the RF receiver housing or other means for interconnecting the interconnection portions to the conductive contacts. Such means may include, by way of example, at least one movable conductive contact in the receiver housing that accommodates the adjustable spacing of the interconnection portions.

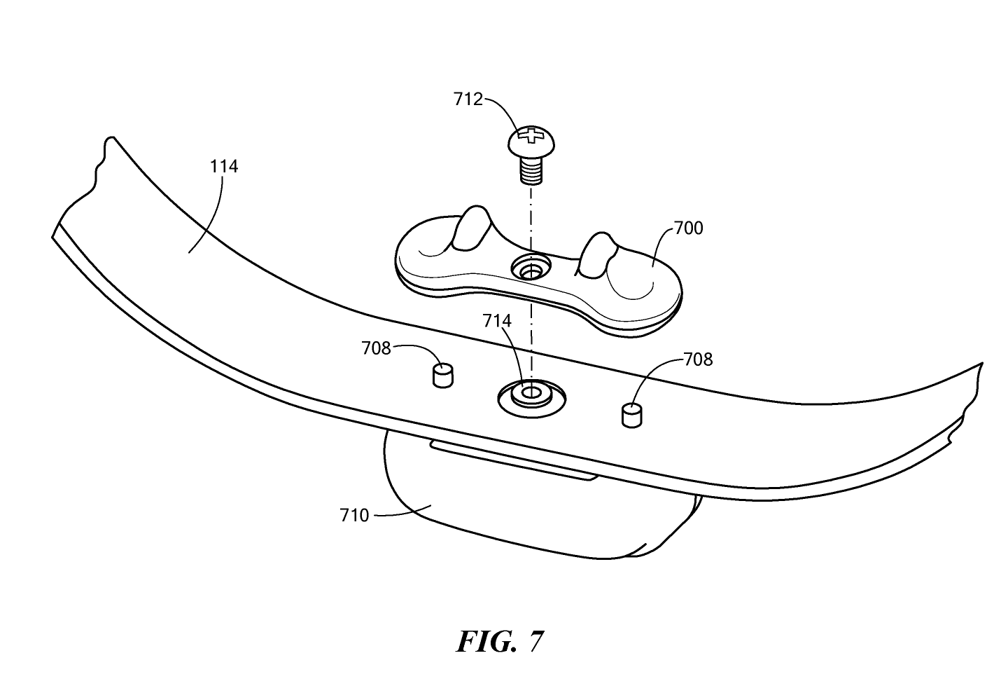

FIG. 7 illustrates another embodiment of a contact unit 700 in which the interconnection portions and the ends of the base portion do not include through-holes. In this embodiment, the undersurface of the interconnection portions of the contact probes are configured so as to substantially conform to the surface of the conductive contacts 708 of the RF receiver housing 710 and abut the conductive contacts 708 in electrically conductive relation when the contact unit 700 is secured to the RF receiver housing 710. In the illustrated embodiment, a single fastener 712 is employed to secure the contact unit 700 to the receiver housing 710. More specifically, the fastener 712, which is a threaded screw in the illustrated embodiment, extends through an opening in the base portion and mechanically engages a threaded member 714 to secure the contact unit 700 to the receiver housing 710. In the illustrated embodiment, the fastener 712 serves to urge the undersurface of the interconnection portions of the contact probes against the upper surface of the conductive contacts 708 to maintain the interconnection portions in electrically conductive relation with the conductive contacts 708. It should be recognized that multiple fasteners may also be employed to secure the contact unit 700 to the receiver housing 710 that extend through the base portion but do not extend through the interconnection portions of the contact probes.

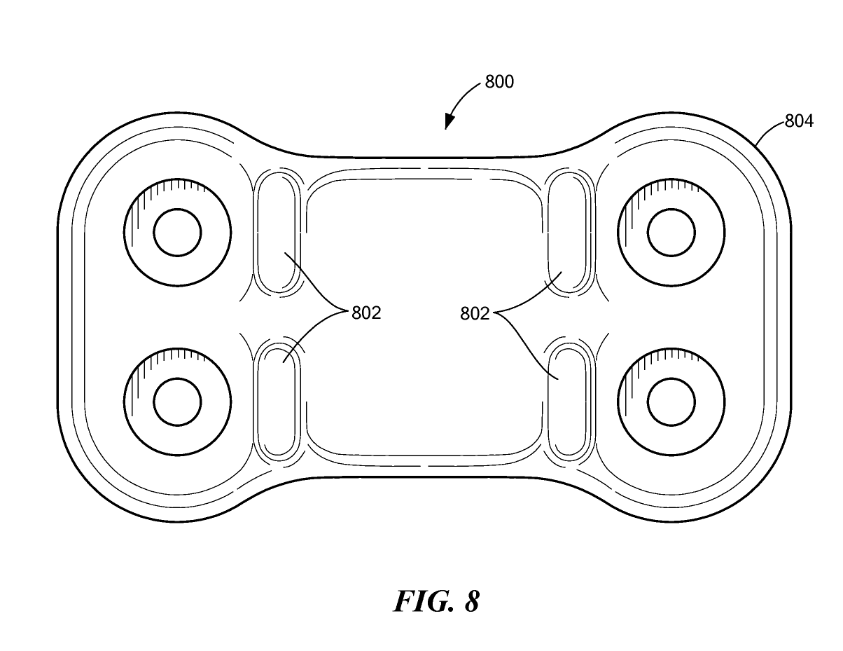

Other embodiments may include more than two contact probes. For example, FIG. 8 illustrates an embodiment of a contact unit 800 in which four contact probes 802 are molded into a single base portion 804. The use of more than two contact probes 802 can be advantageous to improve the conductive contact of the probes to the skin of an animal and thereby more reliably impart an electrical stimulus to the animal upon activation of the stimulus generator. The contact probes 802 may be molded individually as illustrated in FIG. 2 or alternatively, a single molded electrically conductive structure for a contact probe may be provided that includes multiple probe tips.

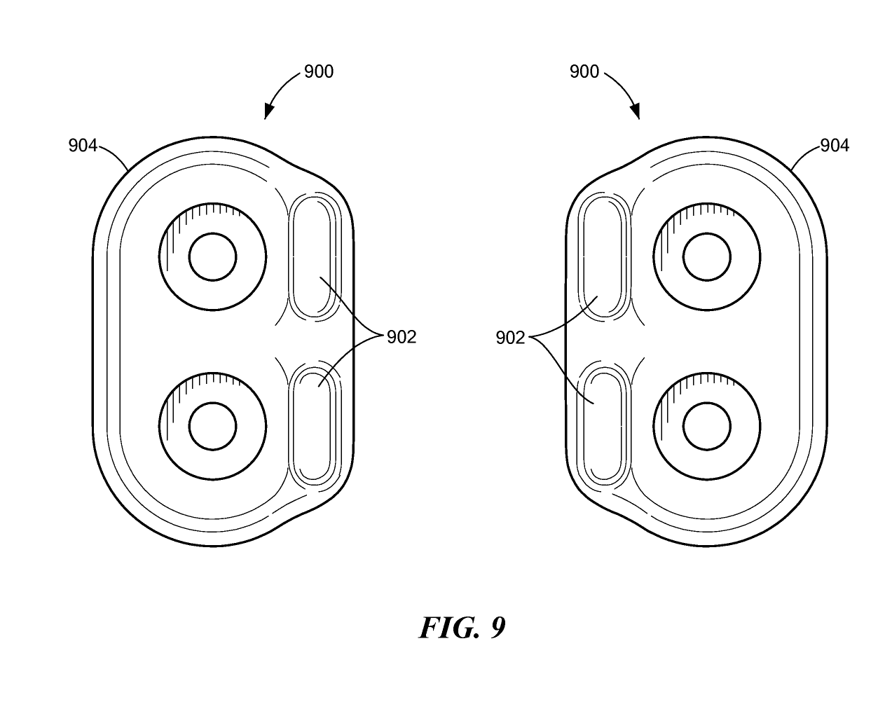

In yet another embodiment of a contact unit 900, illustrated in FIG. 9, two contact probes 902 are molded into each of two separate base portions 904. The contact probes 902 in each base portion may be formed as separate contact probes as depicted in FIG. 2 or molded as an integral unit having one interconnection portion and multiple probe tips. By forming the base portions 904 as separate units, the distance between the contact probes 902 in opposed base portions 904 may be varied when mounting the base portions 904 to the RF receiver housing. The ability to vary the spacing between the base portions and thus the probe tips allows the contact unit configuration to be adjusted to accommodate animals of different size and hair texture. While two contact probes are illustrated in each of the opposed base portions 904, it should be appreciated that one or more contact probes may be provided in each of the two opposed base portions 904.

While several embodiments of contact units have been illustrated, it should be appreciated that the contact units may be formed with other numbers of contact probes. Additionally, other base configurations are contemplated that are distinct from and mountable to an RF receiver housing.

The interconnection portions of the contact probes may be electrically interconnected to the conductive contacts of the RF receiver housing in various ways. For example, a conductive fastener may be used to releasably secure and electrically interconnect the interconnection portion to a corresponding electrical contact of the RF receiver housing as previously described. Alternatively, the interconnection portions of the contact probes and the conductive contacts of the RF receiver housing may be configured and cooperative so as to abut one another in electrically conductive relation when the respective base portion is secured to the RF receiver housing via an electrically conductive or non-conductive fastener. In such an embodiment, it should be recognized that the interconnection portion of the contact probes need not have an opening therethrough for fastening the base portion to the RF receiver housing.

In the foregoing manner a contact unit is provided that is releasably securable to an RF receiver and that may be fabricated using high volume and low cost manufacturing techniques. The contact unit of the present invention thus permits the replacement of only the contact unit should replacement of just the contact unit become necessary.

The contact units, as described above, are employed in conjunction with an RF receiver in animal containment/exclusion systems in which an animal is provided an electrical stimulus when it approaches an antenna wire as noted previously, or in remote to remote activation by a trainer via an RF transmitter. In these applications, a controller that is operative to generate an electrical stimulus includes the RF receiver within a controller housing. It should be recognized that the contact units presently described may also be employed with controllers that contain electrical stimulus generating circuitry responsive to other inputs. For example, the contact units may be employed in conjunction with a controller that generates an electrical stimulus in response to an audible input, such as barking. Additionally, the presently described contact units may be employed with controllers that generate an electrical stimulus in response to a pressure input, linear or rotary motion, a vibration input or any other suitable input that is employed to initiate the generation of an electrical stimulus that is conveyed to the contact probes of the contact unit.

It will be appreciated by those of ordinary skill in the art that modifications to and variations of the above described contact unit and associated methods for making and using the same may be made without departing from the inventive concepts disclosed herein. Accordingly, the invention should not be viewed as limited except by the scope and spirit of the appended claims.

What is claimed is:

1. A contact unit for an animal training system, the contact unit for mounting to a controller housing containing electrical stimulus generating circuitry, the controller housing having conductive contacts mounted in the housing, the contact unit comprising:
at least one base portion formed of a moldable electrically non-conductive material;
a pair of electrically conductive contact probes formed of a moldable electrically conductive material as a single piece integral unit, each contact probe including:
an interconnection portion configured for electrical interconnection with the conductive contacts; and
a probe tip portion in electrically conductive relation with the interconnection portion;
wherein the probe tip portions extend outward from the upper surface of the at least one base portion with the interconnection portions of the contact probes disposed within the at least one base portion, and wherein the interconnection portions are configured to be in electrically conductive relation with the conductive contacts upon mounting of the contact unit to the controller housing.

2. The contact unit of claim 1 wherein the interconnection portions are spaced by a predetermined distance so as to align with conductive contacts of the controller housing and the interconnection portions each have an undersurface that is configured to mate with a corresponding conductive contact in conductive abutting relation upon mounting of contact unit to the controller housing.

3. The contact unit of claim 1 wherein each probe tip portion includes a generally dome shaped outer surface.

4. The contact unit of claim 1 wherein the base portion is a molded structure formed from an electrically non-conductive polymer.

5. The contact unit of claim 4 wherein the base portion is fabricated of a plastic or rubber.

6. The contact unit of claim 1 wherein the contact probes are molded structures formed from an electrically conductive polymer.

7. The contact unit of claim 6 wherein the contact probes are fabricated from a plastic or rubber including a conductive additive.

8. The contact unit of claim 1 wherein the contract probes further include a stem portion, wherein the interconnection portions are generally washer-shaped portions having an opening therethrough and include a side section at one side thereof, wherein the stem portion extends from the side section of the washer-shaped portion to the probe tip portion to conductively interconnect the generally washer-shaped portion to the probe tip portion.

9. The contact unit of claim 1 further including a fastener extending through the opening in each generally washer-shaped portion for releasably engaging the conductive contact to releasably secure the contact unit to the controller housing.

10. The contact unit of claim 9 wherein each generally washer-shaped portion includes an upper surface and the fastener is a conductive screw that is configured to conductively engage the upper surface of the generally washer-shaped portion and a corresponding conductive contact in the controller housing to electrically interconnect the contact probe to the respective conductive contact upon mounting of the contact unit to the controller housing.

11. The contact unit of claim 1 wherein the at least one base portion is a single base portion having at least two contact probes molded therein.

12. The contact unit of claim 1 wherein the at least one base portion comprises two distinct base portions, each base portion including at least one contact probe molded therein.

13. The contact unit of claim 1 wherein the at least one base portion comprises two distinct base portions, wherein each of the base portions includes at least two contact probes molded into each of the base portions.

14. Apparatus for use in an animal training system comprising:
a controller housing containing electrical stimulus generating circuitry, the controller housing having at least two spaced electrically conductive contacts mounted in the housing;
a contact unit comprising:
at least one molded base portion formed of an electrically non-conductive material;
at least two molded electrically conductive contact probes disposed in spaced relation within the at least one base portion, each contact probe having:
an interconnection portion; and
a probe tip portion in electrical communication with the interconnection portion, the probe tip portion for making contact with the skin of an animal, the probe tip portion extending above the upper surface of the at least one base portion; and
at least one fastener releasably securing the at least one base portion to the controller housing with the interconnection portions of the contact probes in electrically conductive relation with corresponding conductive contacts in the controller housing.

15. The apparatus of claim 14 wherein the at least one base portion is a moldable electrically non-conductive polymer.

16. The apparatus of claim 14 wherein the contact probes are molded structures formed from an electrically conductive polymer.

17. The apparatus of claim 16 wherein the electrically conductive polymer includes an electrically non-conductive polymer and a conductive additive.

18. The apparatus of claim 14 wherein the interconnection portions of the contact probes are spaced with respect to one another and configured to mate with the conductive contacts of the controller housing in conductive abutting relation when the at least one base portion is mounted to the controller housing.

19. The apparatus of claim 14 wherein the interconnection portions and the at least one base portion include co-axially aligned openings extending therethrough and the at least one fastener comprises a pair of fasteners that extend through the respective co-axially aligned openings, the pair of fasteners releasably engaging the conductive contacts of the controller housing to releasably secure the contact unit to the controller housing.

20. The apparatus of claim 19 wherein the fasteners comprise conductive fasteners, the interconnection portions include a conductive upper surface and the conductive fasteners engage the conductive upper surface of the interconnection portions and respective conductive contacts mounted in the controller housing to releasably secure the contact unit to the controller housing with the interconnection portions in electrically conductive relation with the conductive contacts.

21. The apparatus of claim 20 further including a collar configured for securing around the neck of an animal, the collar having a pair of openings therethrough disposed in spaced relation for alignment with the openings in the interconnection portions of the contact probes, wherein the collar is disposed between the contact unit and the controller housing and releasably secured therebetween with the respective conductive fasteners extending through the spaced openings in the collar.

22. The apparatus of claim 14 wherein the at least one base portion is a single base portion having at least two contact probes molded therein.

23. The contact unit of claim 14 wherein the at least one base portion comprises two distinct base portions, each base portion including at least one contact probe molded therein.

24. The contact unit of claim 14 wherein the at least one base portion comprises two distinct base portions, wherein each of the base portions includes at least two contact probes molded into each of the base portions.

25. A method for producing a contact unit comprising:
in a first molding operation, molding in at least one first mold, electrically conductive contact probes, each contact probe including:
an interconnection portion having an opening extending therethrough;
a probe tip portion; and
a stem portion extending from and conductively coupling the interconnection portion to the probe tip portion;
inserting the pair of electrically conductive contact probes in a second mold and aligning the contact probes within the mold;
in a second molding step, molding in the second mold a base portion at least partially around at least two contact probes, wherein the second mold is configured such that following the second molding operation each probe tip portion extends outward from an upper surface of the base portion with the openings in interconnection portion of the contact probes disposed in alignment with a corresponding through-hole extending through the base portion.

26. The method of claim 25 further including:
releasably mounting the contact unit to a controller housing using a pair of fasteners that extend through and engage respective interconnection portions and conductive contacts mounted in the controller housing.

27. The method of claim 26 wherein the fasteners are conductive fasteners.

28. The method of claim 25 further including releasably mounting the contact unit to a controller housing using at least one conductive fastener.

29. The method of claim 25 further including releasably mounting the contact unit to a controller housing using at least one non-conductive fastener.

30. A method for producing a contact unit comprising:
in a first molding operation, forming in a first mold from a non-conductive polymer, a base portion having an upper surface, a pair of through-holes and a pair of passages extending therethrough;
inserting the base portion into a second mold and aligning the base portion within the second mold;
in a second molding operation, forming from an electrically conductive polymer, a pair of spaced conductive contact probes, each contact probe having a stem portion formed within a corresponding passage of the base portion, a probe tip portion extending outward from the base portion and an interconnection portion having an opening therethrough in alignment with a corresponding through-hole of the base portion.

31. The method of claim 30 further including:
releasably mounting the contact unit to a controller housing using a pair of electrically conductive fasteners that extend through and conductively engage respective interconnection portions and conductive contacts mounted in the RF receiver housing to conductively interconnect the respective conductive contacts with the contact probes.

32. The method of claim 29 wherein the conductive fasteners are conductive screws.

33. The method of claim 30 further including releasably mounting the contact unit to a controller housing using at least one conductive fastener.

34. The method of claim 30 further including releasably mounting the contact unit to a controller housing using at least one non-conductive fastener.
